(19) United States
(12) Patent Application Publication
(10) Pub. No.: US 2020/0384321 A1
(43) Pub. Date: Dec. 10, 2020

(54) GOLF CLUB SHAFT AND METHOD FOR PRODUCING SAME

(71) Applicant: NIPPON STEEL NISSHIN CO., LTD., Tokyo (JP)

(72) Inventor: Hironori KUBO, Tokyo (JP)

(73) Assignee: NIPPON STEEL NISSHIN CO., LTD., Tokyo (JP)

(21) Appl. No.: 16/484,975

(22) PCT Filed: Mar. 2, 2017
(86) PCT No.: PCT/JP2017/008290

§ 371 Date: Aug. 9, 2019

(51) Int. Cl. A63B 53/12; B21C 37/08

(52) U.S. Cl. CPC A63B 53/12; B23K 2101/06; B21C 37/08

(57) ABSTRACT

The golf club shaft of this invention contains C in an amount of 0.4 mass % to 0.65 mass %, Si in an amount of more than 0 mass % and not more than 0.80 mass %, Mn in an amount of 0.1 mass % to 1.50 mass %, Cr in an amount of more than 0 mass % and less than 0.30 mass %, and at least one element selected from the group consisting of V in an amount of 0.05 mass % to 0.40 mass %, Nb in an amount of 0.03 mass % to 0.15 mass % and Ti in an amount of 0.01 mass % to 0.10 mass %, with the balance consisting of Fe and unavoidable impurities, and has a metal structure in which an area ratio of undissolved cementite is not more than 0.5%.

### TECHNICAL FIELD

This invention relates to a steel shaft used in a golf club (hereinafter referred to as a “golf club shaft”), and a method for producing same.

### BACKGROUND ART

Golf club shafts require strength in order to improve ball flight distance and processability and also from the perspective of safety in terms of golf club shafts not breaking or rupturing during use. In addition, demands have increased in recent years for golf club shafts to be lighter.

In order to make a golf club shaft lighter, it is essential to reduce the wall thickness or diameter of the golf club shaft. However, by reducing the wall thickness or diameter of a steel tube used as a material of a conventional golf club shaft, the breaking strength and rupture strength of the golf club shaft decrease. Therefore, it is essential to improve the strength and ductility of a conventional golf club shaft in order to reduce the weight of the golf club shaft while simultaneously ensuring safety.

In the past, it has been indicated that characteristics of golf club shafts, such as elasticity, strength and ductility, can be improved by selecting the steel composition and heat treatment conditions as appropriate (for example, see Patent Documents 1 to 3).

### CITATION LIST

### Patent Document

Patent Document 1: Japanese Examined Patent Publication No. H03-44126

Patent Document 2: Japanese Patent Application Publication No. 2005-13535

Patent Document 3: Japanese Patent Application Publication No. 2005-34517

### SUMMARY OF INVENTION

### Technical Problem

However, because conventional golf club shafts are not sufficiently strong, it is not possible to reduce weight while ensuring safety. In fact, in order to reduce the weight of a golf club shaft, it is essential to increase the strength of the shaft by at least 50 HV (and preferably 100 HV) from the current level (generally 550 HV) and ensure a level of ductility that is not less than the current level, but it has not been possible to obtain a golf club shaft that exhibits such strength and ductility at the same time.

Increasing the amount of a component such as C and lowering the tempering temperature have been considered as means for increasing the strength of golf club shafts. However, increasing the amount of a component such as C causes ductility to decrease. In addition, lowering the tempering temperature causes ductility to decrease or brings about variations in ductility, and therefore causes reliability to deteriorate.

This invention has been developed in order to solve problems such as those mentioned above, and has the purpose of providing a golf club shaft which exhibits high strength and ductility, has little variation in ductility and enables a reduction in weight; and a method for producing same.

### Solution to Problem

As a result of continued diligent research into means for solving problems such as those mentioned above, the inventors of this invention found that by producing a suitable metal structure by selecting the steel composition and heat treatment conditions as appropriate, it is possible to suppress variations in ductility while increasing strength and ductility.

That is, this invention is a golf club shaft, the golf club shaft comprises C in an amount of 0.4 mass % to 0.65 mass %, Si in an amount of more than 0 mass % and not more than 0.80 mass %, Mn in an amount of 0.1 mass % to 1.50 mass %, Cr in an amount of more than 0 mass % and less than 0.30 mass %, and at least one element selected from the group consisting of V in an amount of 0.05 mass % to 0.40 mass %, Nb in an amount of 0.03 mass % to 0.15 mass % and Ti in an amount of 0.01 mass % to 0.10 mass %, with the balance consisting of Fe and unavoidable impurities, and has a metal structure in which an area ratio of undissolved cementite is not more than 0.5%.

In addition, this invention is a method for producing a golf club shaft, the method comprises molding a welded steel pipe comprising C in an amount of 0.4 mass % to 0.65 mass %, Si in an amount of more than 0 mass % and not more than 0.80 mass %, Mn in an amount of 0.1 mass % to 1.50 mass %, Cr in an amount of more than 0 mass % and less than 0.30 mass %, and at least one element selected from the group consisting of V in an amount of 0.05 mass % to 0.40 mass %, Nb in an amount of 0.03 mass % to 0.15 mass % and Ti in an amount of 0.01 mass % to 0.10 mass %, with the balance consisting of Fe and unavoidable impurities, into the shape of a shaft, and then quenching and tempering so that an area ratio of undissolved cementite is not more than 0.5%.

### Advantageous Effects of Invention

According to this invention, it is possible to provide a golf club shaft which exhibits high strength and ductility, has little variation in ductility and enables a reduction in weight; and a method for producing same.

### DESCRIPTION OF EMBODIMENTS

The golf club shaft and method for producing same of this invention will now be explained in detail.

The golf club shaft of this invention contains C, Si, Mn, Cr and at least one element selected from the group consisting of V, Nb and Ti, with the balance consisting of Fe and unavoidable impurities. In addition, the golf club shaft of this invention can, if necessary, further contain at least one element selected from the group consisting of P and S, at least one element selected from the group consisting of Ni and Mo, or B.

<C: 0.4 Mass % to 0.65 Mass %>

C is a component that affects the strength, yield strength and elasticity of the steel material following heat treatment, and the quenching hardness, strength, and the like, vary according to the content of C. From the perspective of achieving sufficient quenching hardness and strength, the content of C must be not less than 0.4 mass %. However, if the content of C is too high, the malleability and ductility of the steel material decrease following heat treatment, and the content of C must therefore be not more than 0.65 mass %. From the perspective of stably achieving the advantageous effects mentioned above, the content of C is preferably 0.41 mass % to 0.64 mass %, more preferably 0.415 mass % to 0.635 mass %, and further preferably 0.42 mass % to 0.63 mass %.

<Si: More than 0 Mass % and Not More than 0.80 Mass %>

Si is a component that is used as a molten steel deoxidizing agent in a steel making stage. In addition, Si has the effect of increasing temper softening resistance. If the content of Si is too high, the steel material (polished strip steel) becomes hard, meaning that productivity of the golf club shaft decreases. In addition, grain boundary oxidation occurs in the steel material (polished strip steel) production process (annealing process), and surface quality deteriorates. Therefore, the content of Si must be more than 0 mass % and not more than 0.80 mass %. From the perspective of stably achieving the advantageous effects mentioned above, the content of Si is preferably 0.01 mass % to 0.78 mass %, more preferably 0.03 mass % to 0.75 mass %, and further preferably 0.04 mass % to 0.73 mass %.

<Mn: 0.1 Mass % to 1.50 Mass %>

Mn is a component that improves hardenability. From the perspective of achieving sufficient hardenability, the content of Mn must be not less than 0.1 mass %. However, if the content of Mn is too high, the steel material (a polished strip steel) becomes hard, meaning that productivity of the golf club shaft decreases. In addition, the ductility of the steel material decreases following heat treatment. Therefore, the content of Mn must be not more than 1.50 mass %. From the perspective of stably achieving the advantageous effect mentioned above, the content of Mn is preferably 0.2 mass % to 1.48 mass %, more preferably 0.3 mass % to 1.46 mass %, and further preferably 0.35 mass % to 1.44 mass %.

<Cr: More than 0 Mass % and Less than 0.30 Mass %>

Cr, like Mn, is a component that improves hardenability. If the content of Cr is too high, the amount of cementite (undissolved cementite) generated during heat treatment increases. Cementite facilitates the generation and propagation of cracks when rupture occurs, and can cause a decrease in malleability and ductility. Therefore, the content of Cr must be more than 0 mass % and less than 0.30 mass %. From the perspective of stably achieving the advantageous effect mentioned above, the content of Cr is preferably 0.01 mass % to 0.295 mass %, more preferably 0.015 mass % to 0.29 mass %, and further preferably 0.02 mass % to 0.285 mass %.

<V: 0.05 Mass % to 0.40 Mass %>

V is a component that contributes to a reduction in crystal grain size during quenching and improves ductility. From the perspective of sufficiently improving ductility, the content of V must be not less than 0.05 mass %. However, if the content of V is too high, the advantageous effect mentioned above reaches saturation point, and the content of V must therefore be not more than 0.40 mass %. From the perspective of stably achieving the advantageous effect mentioned above, the content of V is preferably 0.06 mass % to 0.38 mass %, more preferably 0.065 mass % to 0.36 mass %, and further preferably 0.07 mass % to 0.35 mass %.

<Nb: 0.03 Mass % to 0.15 Mass %>

Nb, like V, is a component that contributes to a reduction in crystal grain size during quenching and improves ductility. From the perspective of sufficiently improving ductility, the content of Nb must be not less than 0.03 mass %. However, if the content of Nb is too high, the advantageous effect mentioned above reaches saturation point, and the content of Nb must therefore be not more than 0.15 mass %. From the perspective of stably achieving the advantageous effect mentioned above, the content of Nb is preferably 0.035 mass % to 0.14 mass %, more preferably 0.04 mass % to 0.135 mass %, and further preferably 0.045 mass % to 0.13 mass %.

<Ti: 0.01 Mass % to 0.10 Mass %>

Ti, like V and Nb, is a component that contributes to a reduction in crystal grain size during quenching and improves ductility. In addition, because Ti binds strongly to N, it is possible to suppress the production of BN when Ti is blended together with B and ensure a hardenability improvement effect achieved by B. From the perspective of sufficiently achieving such an advantageous effect, the content of Ti must be not less than 0.01 mass %. However, if the content of Ti is too high, the advantageous effect mentioned above reaches saturation point and ductility decreases, and the content of Ti must therefore be not more than 0.10 mass %. From the perspective of stably achieving the advantageous effect mentioned above, the content of Ti is preferably 0.012 mass % to 0.095 mass %, more preferably 0.015 mass % to 0.09 mass %, and further preferably 0.018 mass % to 0.085 mass %.

<P: More than 0 Mass % and not More than 0.03 Mass %>

P is a component that causes a decrease in ductility due to being localized at austenite grain boundaries during quenching and causing a decrease in grain boundary strength. In cases where P is contained, the content of P must be not more than 0.03 mass % from the perspective of reducing this adverse effect on ductility. From the perspective of stably reducing the adverse effect mentioned above, the content of Ti is preferably 0.001 mass % to 0.028 mass %, more preferably 0.003 mass % to 0.026 mass %, and further preferably 0.005 mass % to 0.024 mass %.

<S: More than 0 Mass % and not More than 0.02 Mass %>

S is a component that forms MnS, which acts as a starting point for fatigue fractures in steel, and causes a decrease in ductility. In cases where S is contained, the content of S must be not more than 0.02 mass % from the perspective of reducing this adverse effect on ductility. From the perspective of stably reducing the adverse effect mentioned above, the content of S is preferably 0.001 mass % to 0.0198 mass %, more preferably 0.0015 mass % to 0.0195 mass %, and further preferably 0.002 mass % to 0.0192 mass %.

<Ni: 0.10 Mass % to 2.00 Mass %>

Ni, like Mn and Cr, is a component that improves hardenability. Ni, unlike Mn and Cr, has little adverse effect on ductility even if contained at a relatively large quantity. From the perspective of sufficiently achieving a hardenability improvement effect, the content of Ni must be not less than 0.10 mass %. However, Ni is expensive, and because adding an excessive quantity of Ni is economically disadvantageous, the content of Ni must be not more than 2.00 mass %. From the perspective of stably achieving the advantageous effect mentioned above, the content of Ni is preferably 0.20 mass % to 1.97 mass %, more preferably 0.3 mass % to 1.93 mass %, and further preferably 0.4 mass % to 1.90 mass %.

<Mo: 0.10 Mass % to 1.50 Mass %>

Mo is an effective component for improving ductility. From the perspective of sufficiently achieving a ductility improvement effect, the content of Mo must be not less than 0.10 mass %. However, if the content of Mo is too high, the advantageous effect mentioned above reaches saturation point, and the content of Mo must therefore be not more than 1.50 mass %. From the perspective of stably achieving the advantageous effect mentioned above, the content of Mo is preferably 0.105 mass % to 1.48 mass %, more preferably 0.011 mass % to 1.46 mass %, and further preferably 0.0115 mass % to 1.45 mass %.

<B: 0.0005 Mass % to 0.005 Mass %>

B, like Mn, Cr and Ni, is a component that improves hardenability. From the perspective of sufficiently achieving a hardenability improvement effect, the content of B must be not less than 0.0005 mass %. However, if the content of B is too high, the advantageous effect mentioned above reaches saturation point, and the content of B must therefore be not more than 0.005 mass %. From the perspective of stably achieving the advantageous effect mentioned above, the content of B is preferably 0.001 mass % to 0.0048 mass %, more preferably 0.0015 mass % to 0.0045 mass %, and further preferably 0.0018 mass % to 0.0042 mass %.

<Balance: Fe and Unavoidable Impurities>

The balance other than the components mentioned above consists of Fe and unavoidable impurities. Here, “unavoidable impurities” means components that are difficult to remove, such as O and N. These components are unavoidably incorporated at the stage where the steel material is smelted.

<Area Ratio pf Cementite: not More than 0.5%>

Increasing the strength of a golf club shaft can lead to variations in ductility. In this invention, it was found that such variations in ductility are caused primarily by cementite (undissolved cementite) that remains at the time of quenching, and by making an area ratio of cementite in the metal structure not more than 0.5%, variations in ductility are prevented. Here, the area ratio of cementite means the area ratio of cementite relative to the whole of an arbitrary cross section of the steel material (golf club shaft) following quenching. The area ratio of cementite can be calculated by subjecting a cross section of the steel material to coloring etching or the like, observing the cross section using a publicly known means such as an optical microscope, and then performing image analysis. From the perspective of stably preventing variations in ductility, the area ratio of cementite is preferably not more than 0.49%, more preferably 0.01% to 0.48%, and further preferably 0.05% to 0.47%.

<Production Method>

The golf club shaft of this invention is produced by molding a welded steel pipe having the steel composition mentioned above into the shape of a shaft, and then quenching and tempering the shaft at prescribed temperatures.

The welded steel pipe can be obtained by forming a polished strip steel from a steel material, which has been adjusted so as to have the steel composition mentioned above, using an ordinary method and then forming a pipe using a publicly known welding method such as TIG welding or resistance welding. Conditions in this pipe formation step are not particularly limited as long as a steel material that has been adjusted so as to have the steel composition mentioned above is used.

Quenching is carried out by heating the molded welded steel pipe at a prescribed temperature and then carrying out oil quenching. By heating at the prescribed temperature in this process, the metal structure is sufficiently austenitized, and a martensite structure is modified by the oil quenching. The heating temperature in the quenching correlates with the amount of undissolved cementite, which is a cause of variations in ductility, and it is therefore possible to reduce the amount of undissolved cementite and suppress variations in ductility by controlling the heating temperature.

In order to prevent variations in ductility, quenching must be carried out at a heating temperature such that an area ratio of undissolved cementite is not more than 0.5%. The heating temperature must be adjusted as appropriate according to the steel composition, but is preferably approximately 800° C. or higher from the perspectives of sufficiently austenitizing the metal structure and reducing the amount of undissolved cementite. In addition, the heating temperature is preferably 900° C. or lower from the perspective of preventing an increase in austenite crystal grain size. In cases where the heating temperature is decided in order to make the area ratio of undissolved cementite not more than 0.5%, a procedure such as that described below should be carried out. Quenching is carried out at the temperature mentioned above and the area ratio of undissolved cementite is then measured, and if this value exceeds 0.5%, the heating temperature is increased and quenching is carried out again, after which the area ratio of undissolved cementite is measured again. The heating temperature can be determined by repeating this procedure until the area ratio of undissolved cementite is not more than 0.5%.

Tempering is carried out by heating the quenched welded steel pipe at a prescribed temperature. The heating temperature during tempering must be adjusted as appropriate according to the steel composition, but by making the heating temperature 160° C. to 400° C., it is generally possible to control the hardness to 550 HV to 700 HV.

As described above, by selecting the steel composition and heat treatment conditions as appropriate, it is possible to improve both the strength and ductility of a golf club shaft and reduce the weight of the golf club shaft.

### EXAMPLES

This invention will now be explained in greater detail through the use of examples, but this invention is not limited to the examples shown below.

A cold rolled steel strip (polished strip steel) having a thickness of 0.7 mm was produced by acid washing a hot rolled steel strip having the composition shown in Table 1 below and then repeatedly annealing and cold rolling. Next, a welded steel pipe having a diameter of 19 mm was produced by cutting the cold rolled steel strip into a steel piece having a width of 60 mm, molding the steel piece into an open pipe using a roll molding method, and then resistance welding the ends of the open pipe in the width direction to each other. The obtained welded steel pipe was drawn into the shape of a shaft, heated by being held for 10 minutes at a prescribed temperature, and then quenched in oil at 60° C. Next, a golf club shaft was obtained by heating the steel pipe at a prescribed temperature for 15 minutes and tempering the steel pipe by cooling in air. Moreover, the heating temperature during the quenching (the quenching temperature) and the heating temperature during tempering (the tempering temperature) are shown in Table 2.

TABLE 1

| Steel | Steel composition (mass %) | | | | | | | | | | | |
|---|---|---|---|---|---|---|---|---|---|---|---|---|
| No. | C | Si | Mn | Cr | V | Nb | Ti | P | S | Ni | Mo | B |
| A | 0.52 | 0.05 | 0.50 | 0.05 | 0.10 | 0.05 | — | 0.016 | 0.010 | 1.00 | 1.00 | — |
| B | 0.43 | 0.25 | 0.43 | 0.24 | 0.20 | — | 0.02 | 0.012 | 0.008 | 0.50 | — | 0.004 |
| C | 0.62 | 0.09 | 0.64 | 0.18 | 0.08 | — | — | 0.021 | 0.006 | — | — | — |
| D | 0.45 | 0.72 | 1.42 | 0.08 | 0.30 | — | — | 0.011 | 0.014 | 0.42 | — | — |
| E | 0.60 | 0.17 | 0.42 | 0.28 | 0.10 | — | — | 0.018 | 0.019 | 0.75 | 0.12 | — |
| F | 0.49 | 0.32 | 0.48 | 0.03 | 0.16 | — | 0.08 | 0.019 | 0.003 | — | — | 0.002 |
| G | 0.44 | 0.54 | 0.39 | 0.07 | — | 0.12 | — | 0.023 | 0.004 | 1.87 | 0.19 | — |
| H | 0.51 | 0.25 | 0.44 | 0.11 | — | 0.07 | — | 0.014 | 0.006 | — | 1.44 | — |
| I | 0.55 | 0.19 | 0.52 | 0.27 | — | — | 0.04 | 0.009 | 0.005 | — | — | — |
| J | 0.68 | 0.25 | 0.88 | 0.18 | 0.20 | — | — | 0.018 | 0.006 | — | — | — |
| K | 0.38 | 0.25 | 0.88 | 0.26 | — | 0.05 | — | 0.014 | 0.009 | — | — | — |
| L | 0.62 | 0.42 | 1.62 | 0.28 | 0.12 | 0.06 | — | 0.018 | 0.018 | — | — | — |
| M | 0.54 | 0.20 | 0.80 | 0.43 | 0.20 | — | — | 0.022 | 0.008 | 0.55 | 0.20 | — |
| N | 0.51 | 0.23 | 0.89 | 0.28 | 0.11 | — | — | 0.017 | 0.032 | 0.52 | 0.94 | — |
| O | 0.49 | 0.26 | 0.77 | 0.15 | — | — | — | 0.024 | 0.020 | — | — | — |

(Notes)
Underlined entries are values that fall outside ranges stipulated for this invention.

A test piece was cut from the golf club shaft obtained in the manner described above, and subjected to the following evaluations.

### <Hardness>

Hardness (HV) was measured using a Vickers hardness gauge. The hardness is preferably 640 HV to 660 HV.

### <Area Ratio of Cementite>

A cross section of the test piece was subjected to cementite coloring etching, the cross section was observed using an optical microscope, and an area ratio of cementite was calculated by image analysis. Moreover, the observation region measured 61 μm×61 μm.

<Ductility: Impact Test>

In order to evaluate ductility, a test piece was produced under the same conditions as those used for the polished strip steel having a thickness of 0.7 mm, and the impact value was measured by carrying out a 2 mm U notch impact test using a Charpy impact tester. Here, the number of measurement points was 10 per test piece, and the average value of these is shown as the impact value. Furthermore, the value of A, which is an indicator of variation in impact value (=100×standard deviation/average value), was calculated. In this evaluation, if the impact value is not less than 46 J/cm² and the value of A is not more than 10, it can be said that the golf club shaft has sufficient ductility.

These evaluation results are shown in Table 2.

TABLE 2

| | | | | | Area ratio of | Impact test | | |
|---|---|---|---|---|---|---|---|---|
| | | Quenching | Tempering | | undissolved | Impact | | |
| Sample | Steel | temperature | temperature | Hardness | cementite | value | Value of | |
| No. | No. | (° C.) | (° C.) | (HV) | (%) | (J/cm²) | A | Classification |
| 1 | A | 800 | 200 | 642 | 0.14 | 55.4 | 3.9 | Example |
| 2 | A | 840 | 200 | 650 | 0.11 | 56.2 | 3.9 | Example |
| 3 | B | 880 | 160 | 642 | 0.12 | 60.4 | 3.1 | Example |
| 4 | C | 800 | 200 | 654 | 1.24 | 44.0 | 13.6 | Comparative example |
| 5 | C | 840 | 230 | 647 | 0.28 | 47.4 | 6.3 | Example |
| 6 | D | 840 | 160 | 648 | 0.10 | 60.0 | 3.5 | Example |
| 7 | E | 840 | 200 | 644 | 1.64 | 44.2 | 17.2 | Comparative example |
| 8 | E | 880 | 230 | 647 | 0.46 | 49.0 | 9.4 | Example |
| 9 | F | 840 | 190 | 648 | 0.11 | 57.8 | 4.7 | Example |
| 10 | G | 840 | 170 | 645 | 0.08 | 59.0 | 3.9 | Example |
| 11 | H | 840 | 200 | 644 | 0.18 | 55.4 | 4.8 | Example |
| 12 | I | 860 | 180 | 652 | 0.58 | 48.6 | 11.6 | Comparative example |
| 13 | I | 900 | 200 | 647 | 0.11 | 53.4 | 7.7 | Example |
| 14 | J | 840 | 240 | 644 | 1.02 | 35.6 | 28.5 | Comparative example |
| 15 | J | 880 | 240 | 653 | 0.48 | 36.8 | 11.6 | Comparative example |
| 16 | K | 880 | 160 | 620 | — | — | — | Comparative example |
| 17 | L | 840 | 200 | 649 | 1.68 | 38.4 | 19.7 | Comparative example |
| 18 | L | 880 | 220 | 658 | 0.46 | 41.0 | 8.3 | Comparative example |
| 19 | M | 840 | 180 | 656 | 2.00 | 47.9 | 18.1 | Comparative example |
| 20 | M | 900 | 200 | 648 | 0.53 | 45.4 | 11.4 | Comparative example |
| 21 | N | 840 | 190 | 648 | 0.38 | 41.4 | 11.8 | Comparative example |
| 22 | N | 880 | 190 | 650 | 0.12 | 40.4 | 7.4 | Comparative example |
| 23 | O | 840 | 170 | 652 | 0.22 | 33.8 | 13.8 | Comparative example |
| 24 | O | 880 | 170 | 653 | 0.17 | 29.6 | 8.2 | Comparative example |

(Notes)
Underlined entries are values that fall outside ranges stipulated for this invention.

As shown in Table 2, Sample Nos. 1 to 3, 5 to 6, 8 to 11 and 12 (examples), which were Steel Nos. A to I and in which an area ratio of undissolved cementite was not more than 0.5%, exhibited high strength and ductility and had little variation in ductility.

Conversely, Sample Nos. 4, 7 and 12 (comparative examples), which were Steel Nos. C, E and I and in which the area ratio of undissolved cementite was more than 0.5%, exhibited high strength, but had high variations in ductility (value of A) and exhibited insufficient ductility (impact value).

Sample No. 14 (comparative example), which was Steel No. J, had an excessively high content of C in the steel, meaning that the area ratio of cementite was high, ductility (impact value) was low and variation in ductility (value of A) was also high. In addition, Sample No. 15 (comparative example), which was Steel No. J, had a higher quenching temperature in order to reduce the area ratio of cementite, but ductility (impact value) remained low and variation in ductility (value of A) was not satisfactory.

Sample No. 16 (comparative example), which was Steel No. K, had an excessively low content of C in the steel, meaning that sufficient hardness could not be achieved. Therefore, evaluations other than hardness were not carried out.

Sample No. 17 (comparative example), which was Steel No. L, had an excessively high content of Mn in the steel, meaning that the area ratio of cementite was high, ductility (impact value) was low and variation in ductility (value of A) was also high. In addition, Sample No. 18 (comparative example), which was Steel No. L, had a higher quenching temperature in order to reduce the area ratio of cementite, but ductility (impact value) remained low.

Sample No. 19 (comparative example), which was Steel No. M, had an excessively high content of Cr in the steel, meaning that the area ratio of cementite and variation in ductility (value of A) were high. In addition, Sample No. 20 (comparative example), which was Steel No. M, had a higher quenching temperature in order to reduce the area ratio of cementite, but ductility (impact value) was low and variation in ductility (value of A) was high.

Sample No. 21 (comparative example), which was Steel No. N, had an excessively high content of S in the steel, meaning that ductility (impact value) was low and the variation in ductility (value of A) was high. In addition, Sample No. 22 (comparative example), which was Steel No. N, had a higher quenching temperature and had little variation in ductility (value of A), but ductility (impact value) was not sufficiently improved.

Sample No. 23 (comparative example), which was Steel No. O, did not contain V, Nb or Ti, meaning that ductility (impact value) was low and variation in ductility (value of A) was high. In addition, Sample No. 24 (comparative example), which was Steel No. O, had a higher quenching temperature and had little variation in ductility (value of A), but ductility (impact value) was not sufficiently improved.

As can be understood from the results above, this invention can provide a golf club shaft which exhibits high strength and ductility, has little variation in ductility and enables a reduction in weight; and a method for producing same.

1. A golf club shaft, comprising C in an amount of 0.4 mass % to 0.65 mass %, Si in an amount of more than 0 mass % and not more than 0.80 mass %, Mn in an amount of 0.1 mass % to 1.50 mass %, Cr in an amount of more than 0 mass % and less than 0.30 mass %, and at least one element selected from the group consisting of V in an amount of 0.05 mass % to 0.40 mass %, Nb in an amount of 0.03 mass % to 0.15 mass % and Ti in an amount of 0.01 mass % to 0.10 mass %, with the balance consisting of Fe and unavoidable impurities, and having a metal structure in which an area ratio of undissolved cementite is not more than 0.5%.

2. The golf club shaft according to claim 1, further comprising at least one element selected from the group consisting of P in an amount of more than 0 mass % and not more than 0.03 mass % and S in an amount of more than 0 mass % and not more than 0.02 mass %.

3. The golf club shaft according to claim 1, further comprising at least one element selected from the group consisting of Ni in an amount of 0.10 mass % to 2.00 mass % and Mo in an amount of 0.10 mass % to 1.50 mass %.

4. The golf club shaft according to claim 1, further comprising B in an amount of 0.0005 mass % to 0.005 mass %.

5. The golf club shaft according to claim 1, wherein the golf club shaft has a hardness of 640 HV to 660 HV.

6. A method for producing a golf club shaft, the method comprising molding a welded steel pipe comprising C in an amount of 0.4 mass % to 0.65 mass %, Si in an amount of more than 0 mass % and not more than 0.80 mass %, Mn in an amount of 0.1 mass % to 1.50 mass %, Cr in an amount of more than 0 mass % and less than 0.30 mass %, and at least one element selected from the group consisting of V in an amount of 0.05 mass % to 0.40 mass %, Nb in an amount of 0.03 mass % to 0.15 mass % and Ti in an amount of 0.01 mass % to 0.10 mass %, with the balance consisting of Fe and unavoidable impurities, into the shape of a shaft, and then quenching and tempering so that an area ratio of undissolved cementite is not more than 0.5%.

7. The method for producing a golf club shaft according to claim 6, wherein the welded steel pipe further comprises at least one element selected from the group consisting of P in an amount of more than 0 mass % and not more than 0.03 mass % and S in an amount of more than 0 mass % and not more than 0.02 mass %.

8. The method for producing a golf club shaft according to claim 6, the welded steel pipe further comprises at least one element selected from the group consisting of Ni in an amount of 0.10 mass % to 2.00 mass % and Mo in an amount of 0.10 mass % to 1.50 mass %.

9. The method for producing a golf club shaft according to claim 6, wherein the welded steel pipe further comprises B in an amount of 0.0005 mass % to 0.005 mass %.

10. The method for producing a golf club shaft according to claim 6, wherein the tempering temperature is 160° C. to 400° C.
